(19) United States
(12) Patent Application Publication
(10) Pub. No.: US 2025/0309298 A1
(43) Pub. Date: Oct. 2, 2025

(54) FUEL CELL APPARATUS

(71) Applicant: Honda Motor Co., Ltd., Tokyo (JP)

(72) Inventor: Shota Fujimura, Saitama (JP)

(21) Appl. No.: 19/063,236

(22) Filed: Feb. 25, 2025

(30) Foreign Application Priority Data
Mar. 29, 2024 (JP) 2024-058114

(51) Int. Cl. H01M 8/04664; H01M 8/04082; H01M 8/04089; H01M 8/0444

(52) U.S. Cl. CPC H01M 8/04671; H01M 8/04097; H01M 8/04201; H01M 8/04447

(57) ABSTRACT

A fuel cell apparatus including a fuel cell, a piping unit including a gas supply path for anode gas and a gas discharge path for anode gas, a hydrogen sensor detecting a hydrogen gas contained in the anode gas, and a gas collection cover covering an upper side of the piping unit and forming a storage space having a recessed shape toward the upper side. The gas collection cover includes a side wall covering a periphery of the storage space, and an upper wall closing an opening at an upper end portion of the side wall, the upper wall has a recessed portion formed in a recessed shape toward the upper side, and is provided with a through-hole around the recessed portion communicating the storage space with an external space, and the hydrogen sensor is provided at a bottom portion of the recessed portion.

### CROSS-REFERENCE TO RELATED APPLICATION

This application is based upon and claims the benefit of priority from Japanese Patent Application No. 2024-058114 filed on Mar. 29, 2024, the content of which is incorporated herein by reference.

### BACKGROUND OF THE INVENTION

### Field of the Invention

This invention relates to a fuel cell apparatus.

### Description of the Related Art

A fuel cell vehicle is equipped with a fuel cell that uses hydrogen as the fuel gas. In such a fuel cell vehicle, a hydrogen sensor is provided to detect hydrogen leakage. For example, in the fuel cell vehicle described in Japanese Unexamined Patent Publication No. 2011-079347 (JP 2011-079347 A), a cover member that opens downward is provided to cover the top of the fuel cell, and a hydrogen sensor is installed at the uppermost portion inside the cover member to detect hydrogen. When hydrogen gas leakage occurs, the rising hydrogen gas inside the cover member is detected by the hydrogen sensor located at the uppermost portion. When the hydrogen gas leakage is detected, the fuel cell system is shut down to prevent the dangers associated with the leakage.

By the way, in the configuration of the cover member described above, even after the fuel cell system is shut down due to the detection of hydrogen gas leakage, there is a possibility that high concentration hydrogen gas retains in the cover member opening downward for an extended period. In addition, if the hydrogen sensor located at the uppermost portion in the cover member is exposed to hydrogen gas for a prolonged time, it may lead to deterioration of the sensor.

### SUMMARY OF THE INVENTION

An aspect of the present invention is a fuel cell apparatus including: a fuel cell; a piping unit including a gas supply path supplying an anode gas to the fuel cell and a gas discharge path through which the anode gas discharged from the fuel cell flows; a hydrogen sensor configured to detect a hydrogen gas contained in the anode gas; and a gas collection cover configured to cover an upper side of the piping unit and form a storage space having a recessed shape toward the upper side. The gas collection cover includes a side wall configured to cover a periphery of the storage space, and an upper wall configured to close an opening at an upper end portion of the side wall, the upper wall has a recessed portion formed in a recessed shape toward the upper side, and is provided with a through-hole around the recessed portion to communicate the storage space with an external space, and the hydrogen sensor is provided at a bottom portion of the recessed portion.

### BRIEF DESCRIPTION OF THE DRAWINGS

The objects, features, and advantages of the present invention will become clearer from the following description of embodiments in relation to the attached drawings, in which:

FIG. 1 is a perspective view illustrating an outer appearance of a fuel cell apparatus according to an embodiment of the present invention;

FIG. 2 is a view illustrating an example of a vehicle on which the fuel cell apparatus in FIG. 1 is mounted;

FIG. 3 is a diagram illustrating a configuration of a system of the fuel cell apparatus in FIG. 1;

FIG. 4 is a perspective view of a gas collection cover included in the fuel cell apparatus in FIG. 1;

FIG. 5 is a cross-sectional view of the gas collection cover to which a hydrogen sensor is attached;

FIG. 6 is a diagram illustrating a modification of FIG. 5; and

FIG. 7 is a diagram illustrating another modification of FIG. 5.

### DETAILED DESCRIPTION OF THE INVENTION

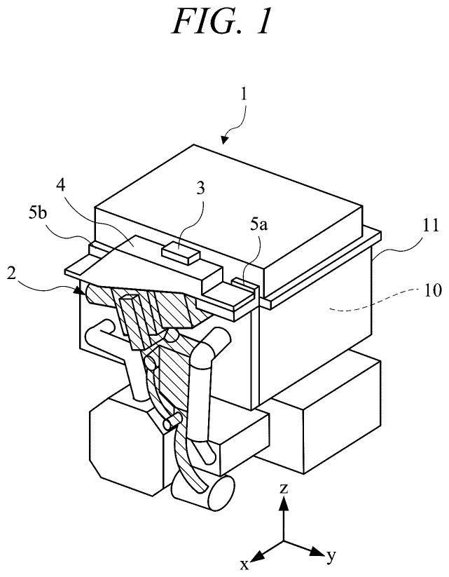

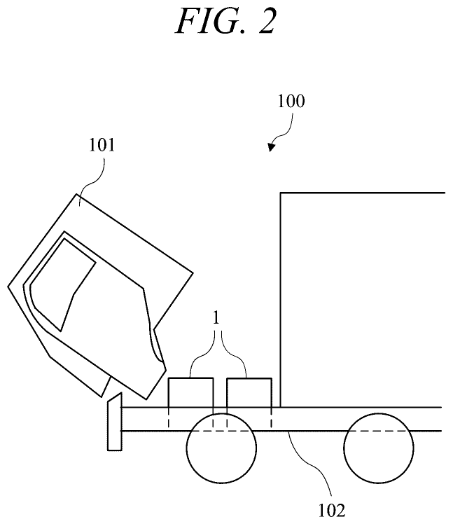

Hereinafter, embodiments of the present invention will be described with reference to FIGS. 1 through 7. FIG. 1 is a perspective view illustrating an outer appearance of fuel cell apparatus 1 according to an embodiment of the present invention. FIG. 1 illustrates directions of three orthogonal axes (X axis, Y axis, Z axis). The Z axis is a vertical direction (gravity direction). For example, as illustrated in FIG. 2, the fuel cell apparatus 1 of the present embodiment is mounted on a commercial vehicle such as a truck, and is used to supply driving power to a traveling motor. The fuel cell apparatus 1 can be used not only in a vehicle but also in various applications such as a large ship and a stationary power supply. As illustrated in FIG. 2, in a large truck, the fuel cell apparatus 1 is disposed on a frame below a cabin provided with a driver's seat. In the case of a small truck or a medium truck, the fuel cell apparatus 1 is mounted in a predetermined space in the frame.

The fuel cell apparatus 1 includes a fuel cell, a gas supply system that supplies anode gas and cathode gas to the fuel cell, a hydrogen detection system that detects leakage of hydrogen gas, which is cathode gas, and the like. A fuel cell (fuel cell stack) 10 is accommodated inside a case 11 in FIG. 1. In FIG. 1, hatched portions represent a piping unit 2 including a device, piping, and the like constituting an anode gas supply system. A gas collection cover 4 provided with a hydrogen sensor 3 for hydrogen detection is disposed above the piping unit 2. The gas collection cover 4 is a cover for collecting hydrogen gas leaked from the piping unit 2, and is fixed to the case 11 by brackets 5a and 5b. A site of the piping unit 2 where the hydrogen gas has a possibility of leaking is a component made of resin, a connection boundary surface between a resin component and the metal component, a piping connecting portion, or the like.

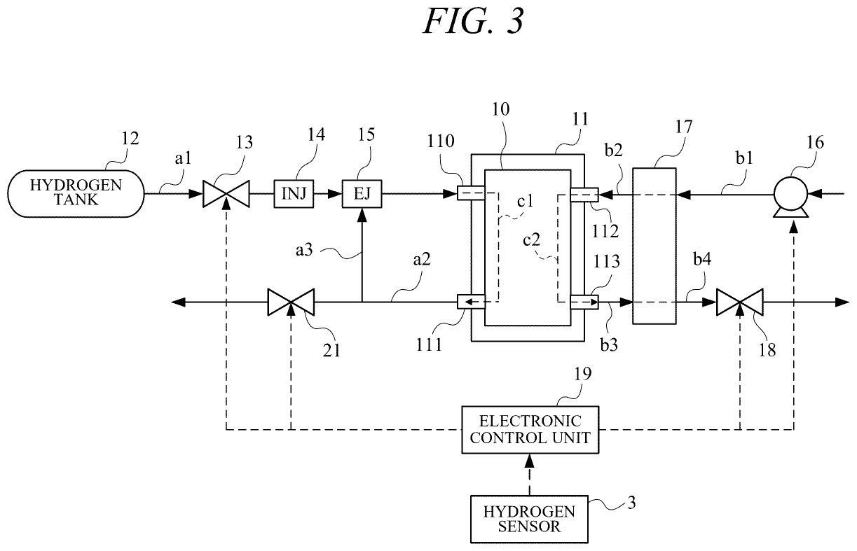

FIG. 3 is a diagram illustrating an example of a system configuration of the fuel cell apparatus 1 mounted on a vehicle. The fuel cell (fuel cell stack) 10 has a cell stacked body formed by stacking a plurality of power generation cells, and the cell stacked body is accommodated in the case 11. The power generation cell is configured such that a polymer electrolyte membrane is sandwiched between an anode electrode and a cathode electrode, and a separator is disposed so as to face the anode electrode and the cathode electrode. An anode flow path c1 through which anode gas (hydrogen gas) flows is formed in the separator disposed facing the anode electrode. A cathode flow path c2 through which cathode gas (air) flows is formed in the separator disposed facing the cathode electrode.

The case 11 accommodating the fuel cell 10 is provided with an anode gas supply port 110 through which the anode gas is introduced, and an anode gas discharge port 111 through which the anode gas, that is, anode exhaust gas (remaining hydrogen gas) is discharged from case 11. Furthermore, the case 11 is provided with a cathode gas supply port 112 for introducing the cathode gas, and a cathode gas discharge port 113 for discharging the cathode gas, that is, cathode exhaust gas from the case 11.

The anode gas supply port 110 is connected to a hydrogen tank 12 via a piping a1, a shut-off valve 13, an injector (injection device) 14, and an ejector 15. A purge valve 21 is connected to the anode gas discharge port 111 via a piping a2. A reflux piping a3 is connected between the anode gas discharge port 111 and the purge valve 21 to the piping a2. The reflux piping a3 is connected to the ejector 15, and the anode exhaust gas discharged from the anode gas discharge port 111 is sucked into the ejector 15 through the reflux piping a3. The anode gas in hydrogen tank 12 is injected from injector 14, and the anode gas and the anode exhaust gas sucked by ejector 15 are supplied to fuel cell 10 through anode gas supply port 110.

The shut-off valve 13 and the purge valve 21 are electromagnetically actuated valves, and are open/close controlled by an electronic control unit 19. The purge valve 21 is opened periodically, for example, and impurities remaining in an anode circulation system (piping a2, reflux piping a3, anode flow path c1) are discharged to the outside via the purge valve 21.

An air compressor 16 is connected to the cathode gas supply port 112 via a piping b1, a humidifier 17, and a piping b2. A back pressure valve 18 is connected to the cathode gas discharge port 113 via a piping b3, the humidifier 17, and a piping b4. The amount of air supplied to the cathode gas supply port 112 by the air compressor 16 is controlled by the electronic control unit 19. The back pressure valve 18 controls the pressure (cathode pressure) of air supplied to the cathode gas supply port 112 by the electronic control unit 19. For example, the cathode pressure is controlled according to a depression amount (throttle opening degree) of an accelerator pedal of the vehicle.

The humidifier 17 removes moisture (water vapor) from the cathode exhaust gas discharged from the cathode gas discharge port 113 and humidifies the cathode gas (air) to be supplied to the cathode gas supply port 112. For example, the humidifier 17 has a hollow fiber membrane bundle obtained by bundling a plurality of hollow fiber membranes having water permeability, where air from the air compressor 16 flows to one side of the inner side and the outer side of each hollow fiber membrane, and cathode exhaust gas discharged from the cathode gas discharge port 113 flows to the other side. The cathode gas is humidified as a result.

A detection signal of the hydrogen sensor 3 is input to the electronic control unit 19. When the hydrogen sensor 3 detects leakage of hydrogen gas, the electronic control unit 19 presents a visual and/or auditory warning to the driver, and performs control to stop power generation of the fuel cell 10 and stop the vehicle.

The piping unit 2 illustrated in FIG. 1 includes some or all of the piping a1 to a3, the shut-off valve 13, the injector 14, the ejector 15, the purge valve 21, the anode gas supply port 110, the anode gas discharge port 111, and the hydrogen tank 12 provided on the anode gas path in FIG. 3. In the example illustrated in FIG. 3, the hydrogen tank 12 is included in the fuel cell apparatus 1, but a hydrogen tank provided separately from the fuel cell apparatus 1 may be mounted on the vehicle.

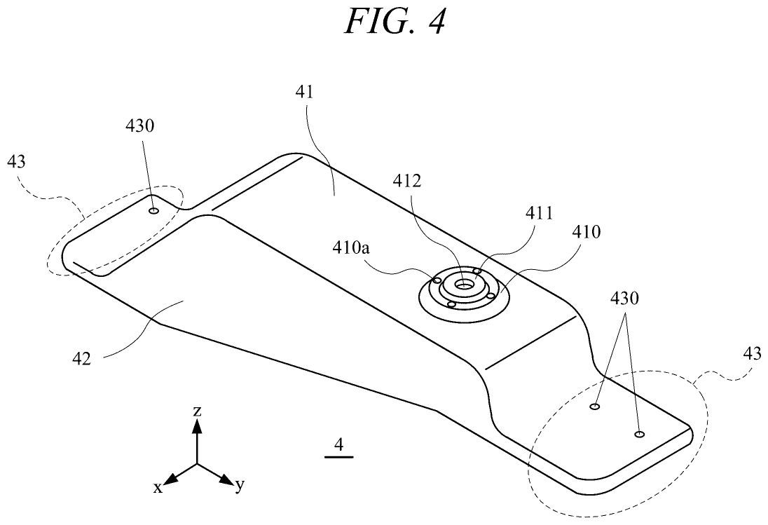

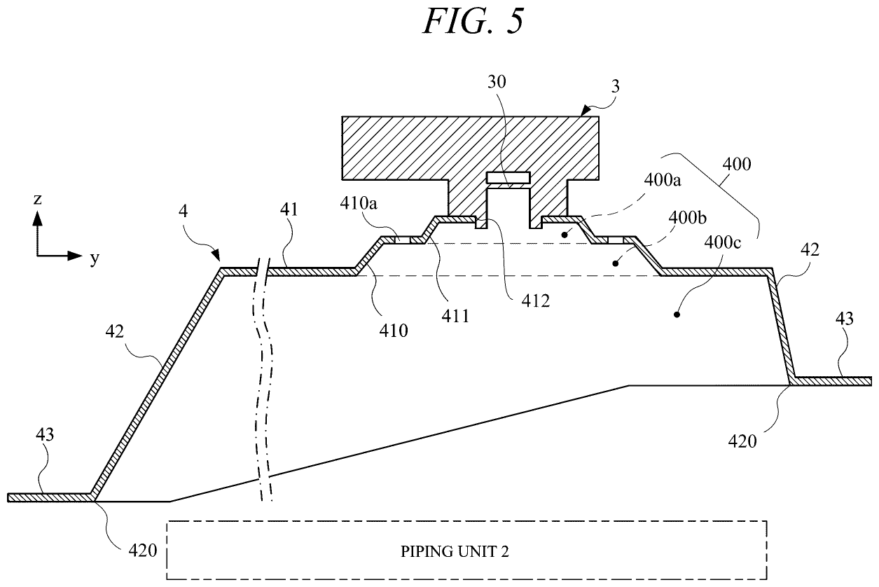

FIG. 4 is a perspective view of the gas collection cover 4 disposed above the piping unit 2, and FIG. 5 is a cross-sectional view of the gas collection cover 4 to which the hydrogen sensor 3 is attached. FIG. 5 corresponds to a cross-sectional view taken along a yz plane orthogonal to the x axis of FIG. 1. The gas collection cover 4 is made of a metal plate or a gas impermeable resin material that does not permeate hydrogen. The gas impermeable resin material can be appropriately selected from synthetic resins such as EVOH (ethylene-vinyl alcohol copolymer), PVA (polyvinyl alcohol), and PP (polypropylene).

As illustrated in FIGS. 4 and 5, the gas collection cover 4 includes a flat plate-shaped upper wall 41, a side wall 42 extending downward from an edge of the upper wall 41, and a fixing portion 43 extending in a substantially horizontal direction (y axis direction) in continuation to a lower end portion of the side wall 42. The fixing portion 43 is fixed to brackets 5a and 5b (see FIG. 1) attached to the case 11. More specifically, a bolt is inserted into a through-hole 430 provided in the fixing portion 43, and the fixing portion 43 is fastened to the brackets 5a and 5b by way of the bolt. A space 400 surrounded by the upper wall 41 and the side wall 42 illustrated in FIG. 5 is a space for storing leaked hydrogen gas for detection, and this space is hereinafter referred to as a storage space 400. At the lower end portion of the side wall 42 surrounding the storage space 400, a downward opening 420 of the gas collection cover 4 is formed.

As illustrated in FIG. 5, a recessed portion (first recessed portion) 410 recessed upward as viewed from the storage space 400 side is formed in the flat plate-shaped upper wall 41. A recessed portion (second recessed portion) 411 further recessed upward is formed at the bottom portion of the recessed portion 410. A through-hole 412 is opened at a central region of the bottom portion of the recessed portion 411. The hydrogen sensor 3 is fixed to the opposite side of the recessed portion 411, that is, the upper surface of the upper wall 41, and the storage space 400 and the hydrogen sensor 3 communicate with each other via the through-hole 412. A plurality of through-holes 410a for ventilation are provided at the periphery of the through-hole 412 at the bottom portion of the recessed portion 410 (see FIG. 4).

The gas collection cover 4 is fixed to the brackets 5a and 5b in FIG. 1 such that the upper wall 41 becomes substantially horizontal. Therefore, the bottom portion of the recessed portion 410 formed in the upper wall 41 is located above the upper end portion of the side wall 42, and the bottom portion of the recessed portion 411 is located above the bottom portion of the recessed portion 410. That is, the upper wall 41 is formed in a stepped shape so as to taper upward.

The hydrogen gas leaked from the piping unit 2 illustrated in FIG. 1 is lighter than air and thus rises. Therefore, a part of the leaked hydrogen gas flows into the storage space 400 from the opening 420 of the gas collection cover 4. Hereinafter, in the storage space 400 of the gas collection cover 4, a recessed region formed by the recessed portion 411 is referred to as a first storage space 400a, a recessed region below the first storage space 400a and formed by the recessed portion 410 is referred to as a second storage space 400b, and a recessed region below the second storage space 400b and formed by the side wall 42 and the upper wall 41 is referred to as a third storage space 400c.

The hydrogen gas that has entered the storage space 400 moves toward the upper wall 41. Then, the hydrogen gas moves from the third storage space 400c to the second storage space 400b on the inner side of the recessed portion 410, and further moves to the first storage space 400a on the inner side of the recessed portion 411. The hydrogen gas concentration increases in the order of the third storage space 400c, the second storage space 400b, and the first storage space 400a. That is, the hydrogen gas concentration in the first storage space 400a is the highest, and the hydrogen gas concentration in the first storage space 400a increases the earliest. The hydrogen gas in the first storage space 400a reaches the detection unit 30 of the hydrogen sensor 3 through the through-hole 412.

As described above, when leakage of hydrogen gas occurs, the hydrogen gas is accumulated in the gas collection cover 4. When the hydrogen concentration detected by the hydrogen sensor 3 becomes greater than or equal to a predetermined level (e.g., 1% to 4%), the electronic control unit 19 determines that hydrogen has leaked. When determined that hydrogen has leaked, the shut-off valve 13 is closed by the electronic control unit 19, the hydrogen gas supply line is shut off, and the actuation of the fuel cell apparatus 1 is stopped (shut down).

When the actuation of the fuel cell apparatus 1 is stopped due to the detection of the leakage of hydrogen, if the hydrogen gas accumulated in storage space 400 is naturally ventilated only through the opening 420, there is a possibility that high concentration hydrogen may remain in gas collection cover 4 for an extended period. In addition, when the hydrogen sensor 3 is a contact combustion type hydrogen sensor, the hydrogen sensor 3 always reacts with the retained hydrogen gas, and the detection unit 30 may deteriorate. In addition, Si reacts with siloxane in the air and is oxidized by combustion heat when hydrogen and the catalyst react with each other, so that a reaction area with the hydrogen gas is reduced, and sensitivity of the hydrogen sensor 3 may be deteriorated.

In this respect, since the gas collection cover 4 of the present embodiment is provided with the through-hole 410a for ventilation, the occurrence of the above-described problem can be prevented. More specifically, as illustrated in FIG. 5, in the present embodiment, a plurality of through-holes 410a are provided at the bottom portion of the recessed portion 410 surrounding the recessed portion 411. Therefore, the hydrogen gas in the storage space 400 is discharged upward from the through-hole 410a. After the operation of the fuel cell apparatus 1 is stopped due to the detection of the leakage of the hydrogen gas, the hydrogen gas in the storage space 400 is discharged through the through-hole 410a, causing the leaked hydrogen gas in the storage space 400 to decrease. As a result, air flows in through the opening 420, enabling smooth ventilation. Therefore, the hydrogen gas concentration decreases in the order of the third storage space 400c, the second storage space 400b, and the first storage space 400a, and the hydrogen concentration in the region (storage space 400) facing the detection unit 30 can be rapidly reduced as compared with the case where there is no through-hole 410a.

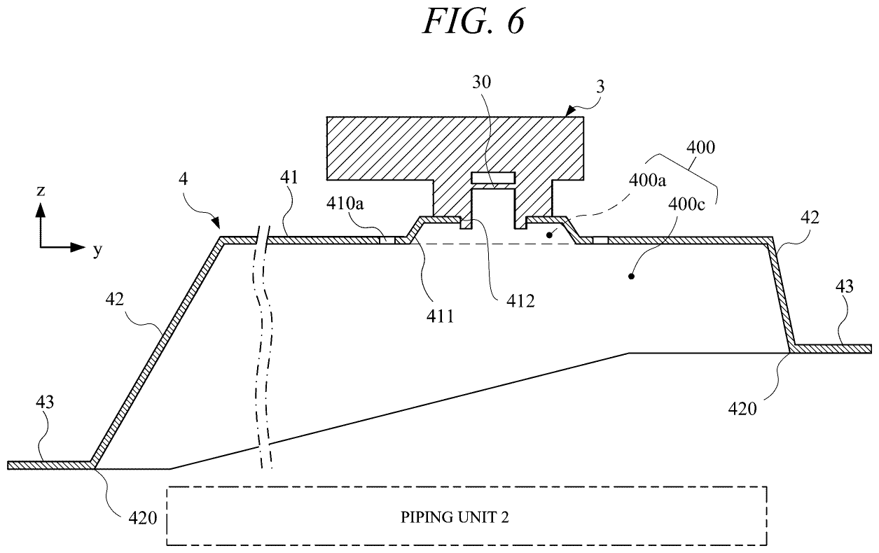

FIG. 6 is a diagram illustrating a modified example of FIG. 5. In the example of FIG. 6, the recessed portion 410 (second storage space 400b) in FIG. 5 is omitted, and the recessed portion 411 is provided in the flat plate-shaped upper wall 41. Furthermore, in the example of FIG. 6, a plurality of through-holes 410a for ventilation are provided in the upper wall 41 at the periphery of the recessed portion 411. Other configurations of the gas collection cover 4 are similar to those illustrated in FIG. 5.

After the operation of the fuel cell apparatus 1 is stopped due to the detection of the leakage of the hydrogen gas, the hydrogen gas in the storage space 400 is discharged through the through-hole 410a, causing the leaked hydrogen gas in the storage space 400 to decrease. As a result, air flows in through the opening 420, and the hydrogen gas concentration decreases in the order of the third storage space 400c and the first storage space 400a. In the example of FIG. 6 as well, the hydrogen concentration in the region facing the detection unit 30 can be rapidly reduced as compared with the case where there is no through-hole 410a.

However, the upper wall 41 of FIG. 5 is more superior in strength of the gas collection cover 4. That is, in FIG. 5, since the upper wall 41 is formed in an uneven shape over a wide range, the strength of the gas collection cover 4 can be further enhanced as compared with the configuration of FIG. 6.

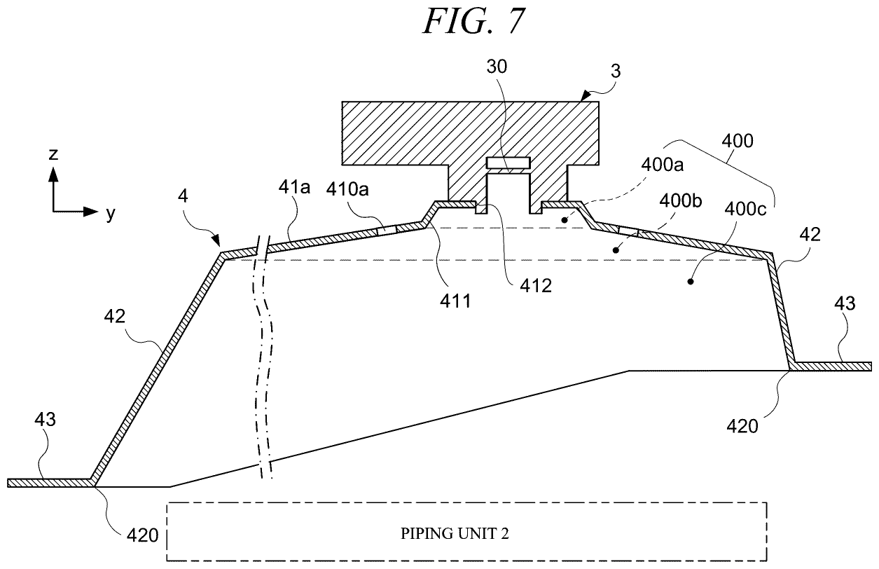

FIG. 7 is a diagram illustrating another modified example of FIG. 5. In FIG. 5, the recessed portion 410 is provided in the upper wall 41 to form the second storage space 400b, but in the example of FIG. 7, the recessed portion 410 is omitted, and the entire upper wall 41 is configured as the inclined upper wall 41a. The inclined upper wall 41a is formed along an inclined surface of ascending slope from the upper end portion of the side wall 42 toward the recessed portion 411. The inclination angle of the inclined upper wall 41a with respect to the horizontal line is smaller than the inclination angle of the side wall 42 with respect to the horizontal line. A region above the side wall 42 and below the inclined upper wall 41a is the second storage space 400b. A plurality of through-holes 410a for ventilation are opened in the inclined upper wall 41a. The through-hole 410a is preferably disposed in the vicinity of the recessed portion 411. Other configurations of the gas collection cover 4 are similar to those illustrated in FIG. 5.

In the gas collection cover 4 illustrated in FIGS. 5 and 6, the upper wall 41 and the recessed portion 410 in which the through-hole 410a is provided are substantially horizontal, and thus foreign matter may adhere to the upper surface of the gas collection cover 4, and the through-hole 410a may be closed by the foreign matter. In this regard, in the example of FIG. 7, the inclined upper wall 41a is configured as an inclined surface of descending slope toward the side wall 42, and thus foreign matter slides off from the upper surface of the inclined upper wall 41a and hardly adheres thereto, thereby reducing the possibility of the through-hole 410a being closed by foreign matter. Therefore, deterioration in ventilation performance of the through-hole 410a due to adhesion of foreign matter or the like can be prevented.

A configuration of the fuel cell apparatus 1 according to the present embodiment is summarized as follows.

(1) A fuel cell apparatus 1 includes a fuel cell (fuel cell stack) 10, a piping unit 2 including a piping (gas supply path) a1 that supplies anode gas to the fuel cell 10 and a piping (gas discharge path) a2 through which the anode gas discharged from fuel cell 10 flows, a hydrogen sensor 3 that detects hydrogen gas contained in the anode gas, and a gas collection cover 4 that covers an upper side of the piping unit 2 and forms a storage space 400 having a recessed shape toward the upper side (FIGS. 1, 3, and 4). The gas collection cover 4 includes a side wall 42 that covers the periphery of the storage space 400 and an upper wall 41 that closes an opening at an upper end portion of the side wall 42 (FIGS. 4 and 5). The upper wall 41 has a recessed portion 411 formed in a recessed shape toward the upper side, and a through-hole 410a communicating the storage space 400 and the external space is opened at the periphery of the recessed portion 411 (FIGS. 5 through 7). The hydrogen sensor 3 is provided at the bottom portion of the recessed portion 411 (FIGS. 5 through 7).
(2) The piping unit 2 further includes a reflux piping a3 (gas circulation path) branching from the piping a2 to the piping a1 (FIG. 3). The piping a1 is provided with a hydrogen tank 12 that stores hydrogen gas, a shut-off valve (valve) 13 that adjusts the flow of hydrogen gas, and an injector (injection device) 14 that injects hydrogen gas (FIG. 3).

(3) The side wall 42 is formed to be inclined upward and toward the recessed portion 411 (FIGS. 5 through 7).

(4) The upper wall 41 is formed to be inclined in an ascending slope from the upper end portion of the side wall 42 toward the recessed portion 411 (FIG. 7).

(5) The upper wall 41 further includes another recessed portion 410 formed in a recessed shape toward the upper side from the upper wall 41 at the periphery of the recessed portion 411, and the recessed portion 411 is formed in a recessed shape toward the upper side from the bottom surface of the other recessed portion 410 (FIG. 5).

(6) The through-hole 410a is provided at the bottom portion of the other recessed portion 410 (FIG. 5).

(7) The hydrogen sensor 3 is provided in communication with the through-hole 412 opened at the bottom portion of the recessed portion 411 (FIGS. 5 through 7).

The above embodiment can be combined as desired with one or more of the above modifications. The modifications can also be combined with one another.

According to the present invention, it is possible to prevent hydrogen gas from remaining inside a cover for an extended period.

Above, while the present invention has been described with reference to the preferred embodiments thereof, it will be understood, by those skilled in the art, that various changes and modifications may be made thereto without departing from the scope of the appended claims.

What is claimed is:

1. A fuel cell apparatus comprising:
a fuel cell;
a piping unit including a gas supply path supplying an anode gas to the fuel cell and a gas discharge path through which the anode gas discharged from the fuel cell flows;
a hydrogen sensor configured to detect a hydrogen gas contained in the anode gas; and
a gas collection cover configured to cover an upper side of the piping unit and form a storage space having a recessed shape toward the upper side, wherein
the gas collection cover includes a side wall configured to cover a periphery of the storage space, and an upper wall configured to close an opening at an upper end portion of the side wall,
the upper wall has a recessed portion formed in a recessed shape toward the upper side, and is provided with a through-hole around the recessed portion to communicate the storage space with an external space, and
the hydrogen sensor is provided at a bottom portion of the recessed portion.

2. The fuel cell apparatus according to claim 1, wherein
the piping unit further includes a gas circulation path branching from the gas discharge path to the gas supply path, and
the gas supply path is provided with a hydrogen tank configured to store the hydrogen gas, a valve configured to adjust a flow of the hydrogen gas, and an injection device configured to inject the hydrogen gas.

3. The fuel cell apparatus according to claim 1, wherein
the side wall is formed to be inclined upward and toward the recessed portion.

4. The fuel cell apparatus according to claim 1, wherein
the upper wall is formed to be inclined in an ascending slope toward the recessed portion from an upper end portion of the side wall.

5. The fuel cell apparatus according to claim 1, wherein
the upper wall further includes another recessed portion formed in a recessed shape toward the upper side from the upper wall around the recessed portion, and
the recessed portion is formed in a recessed shape toward the upper side from a bottom surface of the another recessed portion.

6. The fuel cell apparatus according to claim 5, wherein
the through-hole is provided at the bottom surface of the another recessed portion.

7. The fuel cell apparatus according to claim 1, wherein
the hydrogen sensor is provided in communication with a through-hole opened at the bottom portion of the recessed portion.
